(19) United States
(12) Patent Application Publication
(10) Pub. No.: US 2014/0142972 A1
(43) Pub. Date: May 22, 2014

(54) RELATIVE VALUE UNIT MONITORING SYSTEM AND METHOD

(71) Applicant: Ronald A. Hosenfeld, JR., Columbus, OH (US)

(72) Inventor: Ronald A. Hosenfeld, JR., Columbus, OH (US)

(73) Assignee: LUCID RADIOLOGY SOLUTIONS, LLC, Columbus, OH (US)

(21) Appl. No.: 14/086,121

(22) Filed: Nov. 21, 2013

Related U.S. Application Data
(60) Provisional application No. 61/729,133, filed on Nov. 21, 2012.

(51) Int. Cl. G06Q 10/06; G06Q 50/22

(52) U.S. Cl. CPC G06Q 10/063; G06Q 50/22
USPC 705/2

(57) ABSTRACT

A Relative Value Unit (RVU) monitoring method and system is disclosed that includes passively monitoring network traffic; examining the monitored traffic for recognized patterns in a matching database; deriving detected RVU values from the matching recognized patterns; and updating an RVU tracking database with the detected RVU values. The matching database stores a plurality of recognized patterns and RVU values, and associates the recognized patterns and RVU values. The method can also include notifying the user of detected CPT codes and RVU values. The method can also include determining procedures requested by received medical orders; tracking fulfillment of the requested procedures; and notifying the user when requested procedures remain to be fulfilled. The method can include analyzing data associated with detected patterns to determine if it's a new or previously observed procedure. The method can simultaneously run on multiple computers; and update a common RVU tracking database.

### CROSS-REFERENCE TO RELATED APPLICATIONS

This application claims priority to U.S. Provisional Patent Application Ser. No. 61/729,133, filed Nov. 21, 2012 entitled “Relative Value Unit Monitoring System and Method,” the disclosure of which is expressly incorporated herein by reference.

### BACKGROUND AND SUMMARY

The present invention generally relates to a system and method for processing information, and more specifically to a system and method for the automatic assignment of relative value units based on interpretations of network traffic, including medical data and voice recognition data patterns.

The Relative Value Unit (“RVU”) values are issued by CMS, and indicate the relative difficulty and therefore the amount of pay associated with particular procedures performed by medical practitioners. The RVU values can change from year to year based on emerging technologies or other changes in the medical industry but typically remain consistent over a calendar year.

There is a one-to-one relationship between an RVU value and a Current Procedural Terminology (“CPT”) code. CPT codes are numbers assigned to tasks and services a medical practitioner may provide to a patient including medical, surgical and diagnostic services. These values are used by insurers to determine the amount of reimbursement that a practitioner will receive from the insurer.

However, each medical facility may have multiple procedure values that relate to a particular CPT code. For example, the CPT code may simply be “extremity” but the site may have procedure codes and descriptions for hand, right hand, left hand, wrist, left wrist, right wrist, etc. Adding additional complexity to the matching is the fact that each site can have different procedure codes, and these procedure codes can change over time. This has made the calculation, and therefore the summation, of RVU values difficult. Until recently most medical practitioners would only receive their RVU summation once or twice a year. This is unfortunate because there is tremendous value in real-time feedback of the RVU values.

An RVU monitoring system can provides automatic calculation and assignment of relative value units (RVUs) based upon the monitoring and interpretation of network traffic as it relates to medical and voice recognition data. Network traffic can be monitored on different layers of the Open Systems Interconnection (“OSI”) seven layer model, for example all of layers two through seven of the OSI seven layer model can be monitored. The data can be scanned in a passive manner while searching for recognizable patterns. Within the recognizable patterns, certain repetitive elements can become well-recognized and recorded. These repetitive elements can be used to compare known values in the RVU calculation software with those values observed in the network traffic. The RVU calculation software can be based upon possible commutations and permutations of recognized procedure description terms as they relate to the values assigned within the CPT codes provided through CMS. The RVU monitoring system can also provide comparative analysis and trending for each individual user and groups of users.

A RVU monitoring system for a computer system is disclosed that includes traffic monitoring, pattern recognition and evaluation components that run on a user's computer, and a matching algorithm database accessible by the user's computer. The matching algorithm database stores a plurality of recognized patterns, a plurality of procedure codes, and a plurality of RVU values, and associates each of the procedure codes to an RVU value. The traffic monitoring component passively monitors network traffic entering and leaving the user's computer. The pattern recognition component examines the monitored network traffic for a detected pattern that matches a matching recognized pattern of the plurality of recognized patterns in the matching algorithm database. The evaluation component receives the detected pattern and the matching recognized pattern from the pattern recognition component, uses the matching algorithm database to derive a detected RVU value from the matching recognized pattern, and updates a computer database with the detected RVU value.

The matching algorithm database can also contain a plurality of CPT codes, and can associate each of the plurality of recognized patterns to a procedure code, and associate each of the plurality of procedure codes to a CPT code, and associate each of the plurality of CPT codes to an RVU value. The evaluation component can derive a detected CPT code while deriving the detected RVU value from the matching recognized pattern, and can notify the user of the detected CPT code and the detected RVU value. The evaluation component can update the computer database with the detected RVU value in real-time.

The RVU monitoring system can also include an initialization component that includes local database creation, remote database connection, workstation identification, user identification and registration components. The local database creation component can create a local database on the user's computer for use by the RVU monitoring system on the user's computer. The remote database connection component can connect a remote database to the user's computer for use by the RVU monitoring system on the user's computer. The workstation identification component can automatically determine a computer identifier for the user's computer. The user identification component can determine a user identifier identifying the user of the user's computer. The registration component can record the computer identifier and the user identifier in the local and remote databases. The user identification component can include an automatic user identification component that attempts to determine the user identifier without user interaction; and a self-identification component that is activated when the automatic user identification component fails to determine the user identifier; the self-identification component can prompt the user to enter information enabling determination of the user identifier.

The traffic monitoring component can run HTTP and HTTPS proxy services and packet monitoring services on the user's computer to observe inbound and outbound network and data traffic. The traffic monitoring component can monitor network traffic on multiple levels of the Open Systems Interconnection (OSI) model. The traffic monitoring component can monitor data of voice recognition software programs entering the user's computer.

The RVU monitoring system can also include medical procedure order tracking and order notification components. The medical procedure order tracking component analyzes received medical orders, determines procedures requested by the received medical orders, and tracks the user's fulfillment of the procedures requested by the received medical orders. The order notification component notifies the user when procedures requested by the received medical orders remain to be fulfilled.

The evaluation component can also include a first observation detection component that analyzes associated detection data associated with the detected pattern, determines any identifiers in the associated detection data, examines the detected pattern and the identifiers in the associated detection data to determine whether the detected pattern is associated with a first observation of a process or with a previously observed process.

A Relative Value Unit (RVU) monitoring method for running on a computer system is disclosed. The RVU monitoring method includes passively monitoring network traffic entering and leaving a user's computer; examining the monitored network traffic for detected patterns that match recognized patterns in a matching algorithm database accessible from the user's computer; matching a detected pattern in the monitored network traffic with a matching recognized pattern in the matching algorithm database; deriving a detected RVU value from the matching recognized pattern using the matching algorithm database; and updating an RVU tracking database with the detected RVU value. The matching algorithm database stores a plurality of recognized patterns and a plurality of RVU values, and associates each of the recognized patterns to an RVU value. The RVU monitoring method can also include notifying the user of the detected CPT code and the detected RVU value.

The matching algorithm database can also contain a plurality of procedural codes and a plurality of CPT codes, and the matching algorithm database can associate each of the recognized patterns to an associated procedure code, and associate each of the procedure codes to an associated CPT code, and associate each of the CPT codes to an associated RVU value. Deriving a detected RVU value from the matching recognized pattern using the matching algorithm database can include deriving a detected procedure code from the matching recognized pattern; deriving a detected CPT code from the detected procedure code; and deriving the detected RVU value from the detected CPT code.

The RVU monitoring method can also include connecting a remote database to the user's computer for use by the RVU monitoring method; automatically determining a computer identifier for the user's computer; determining a user identifier identifying the user of the user's computer; and recording the computer identifier and the user identifier in the remote databases. Determining a user identifier can include attempting to automatically determine the user identifier without user interaction; and prompting the user to enter information enabling determination of the user identifier when the attempt to automatically determine the user identifier fails.

The RVU monitoring method can also include determining procedures requested by received medical orders; tracking the user's fulfillment of the procedures requested by the received medical orders; and notifying the user when procedures requested by the received medical orders remain to be fulfilled.

The RVU monitoring method can also include analyzing detection data associated with the detected pattern; determining any unique identifiers in the associated detection data; and comparing the detected pattern and the unique identifiers in the associated detection data with the RVU tracking database to determine whether the detected pattern is associated with a first observation of a medical procedure or with a previously observed medical procedure. If the detected pattern is associated with a first observation of a medical procedure, the method can include recording a new record in the RVU tracking database with information derived from the detected pattern and the associated detection data. If the detected pattern is associated with a previously observed medical procedure, the method can include updating the record in the RVU tracking database for the previously observed medical procedure with any new or changed information derived from the detected pattern and the associated detection data. If it cannot be determined whether the detected pattern is associated with a first observation of a medical procedure or with a previously observed medical procedure, the method can include prompting the user to submit further information to make determination for the detected pattern.

The RVU monitoring method can be run in multiple instances of the RVU monitoring method on separate computers; and update a common RVU tracking database with the detected RVU values of all of the multiple instances of the RVU monitoring method.

### BRIEF DESCRIPTION OF THE DRAWINGS

FIG. 1 illustrates a top-level flow diagram of an exemplary embodiment of an RVU monitoring system;

FIG. 2 illustrates an exemplary embodiment of an initialization procedure that can be used by an RVU monitoring system;

FIG. 3 illustrates an exemplary monitoring, analysis and evaluation embodiment that can be used in an RVU monitoring system;

FIG. 4 illustrates a computer screenshot of an exemplary output of an RVU monitoring system that shows an RVU meter with selection criteria to control the values displayed on the RVU meter; and

FIG. 5 illustrates a computer screenshot of an exemplary output of an RVU monitoring system that shows a visualization of RVU contributions of various members of a group, team or staff over a user selected time period.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The RVU monitoring system monitors network traffic and uses known patterns, comparing those patterns to pre-established patterns based on the flow of medical and voice recognition data as well as structured text data. As the system starts, it can passively monitor network traffic on the user's local computer. This monitoring can be performed on each of layers two through seven of the OSI model.

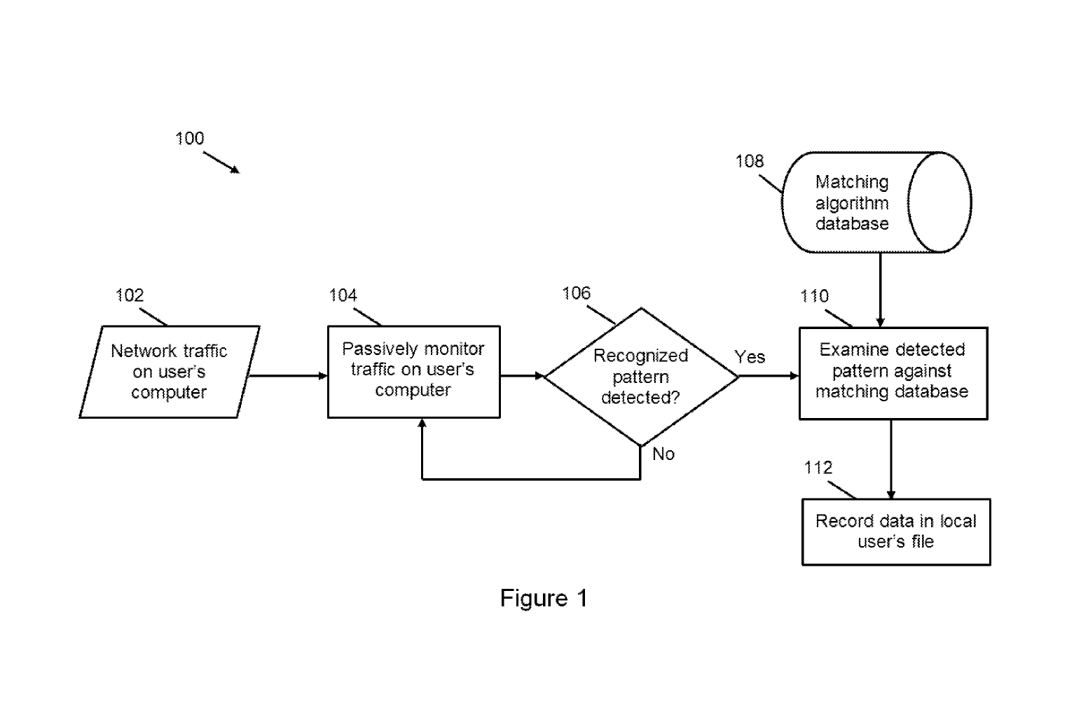

FIG. 1 shows a top-level flow diagram of an exemplary embodiment of an RVU monitoring system 100. Block 102 signifies the network traffic on a user's computer. The user's computer can be any type of computer, workstation, server or other electronic computing device. At block 104, the software system installed and running on the user's computer passively monitors network traffic entering and leaving the user's computer. At block 106, the system examines the network traffic and searches for matching patterns of recognized medical terms and known system events stored in a matching algorithm database 108. The matching algorithm database 108 is stored in memory accessible locally or remotely by the user's computer, and the matching algorithm database 108 includes procedure codes and procedure description values and matching algorithms to associate the procedure codes and/or values to related CPT codes and extrapolate to the RVU values. At block 106, if no matching patterns are detected then the system continues to passively monitor traffic on the user's computer at blocks 104 and 106. At block 106, when a matching pattern is detected, then at block 110 the system examines the recognized pattern that was detected to assign an RVU value using the matching algorithms database 108. At block 110, the system uses the matching algorithms to derive RVU values from the recognized pattern that was detected at block 106 which can include using the detected pattern to identify procedure codes, translating the procedure codes to associated CPT codes, and translating the CPT codes to the associated RVU values. At block 112, the system updates the user's information with the results from the matching performed at block 110. The system can also notify the user of the RVU values, as well as the associated procedure and/or CPT codes, they have performed. These values/codes can be sorted and displayed in many ways depending on the user's preference.

The matching and monitoring of network traffic at the user's computer not only allows for RVU calculations but can also trigger additional actions, for example: (a) workflow steps, (b) communication with other people or systems, (c) real-time billing, and/or (d) patient notification. By monitoring network traffic on the user's computer, server or other electronic device as appropriate, and examining that traffic for patterns of data that is recognized and can be associated with the matching algorithm database, the system can provide real time, nearly instantaneous, RVU value calculations and feedback.

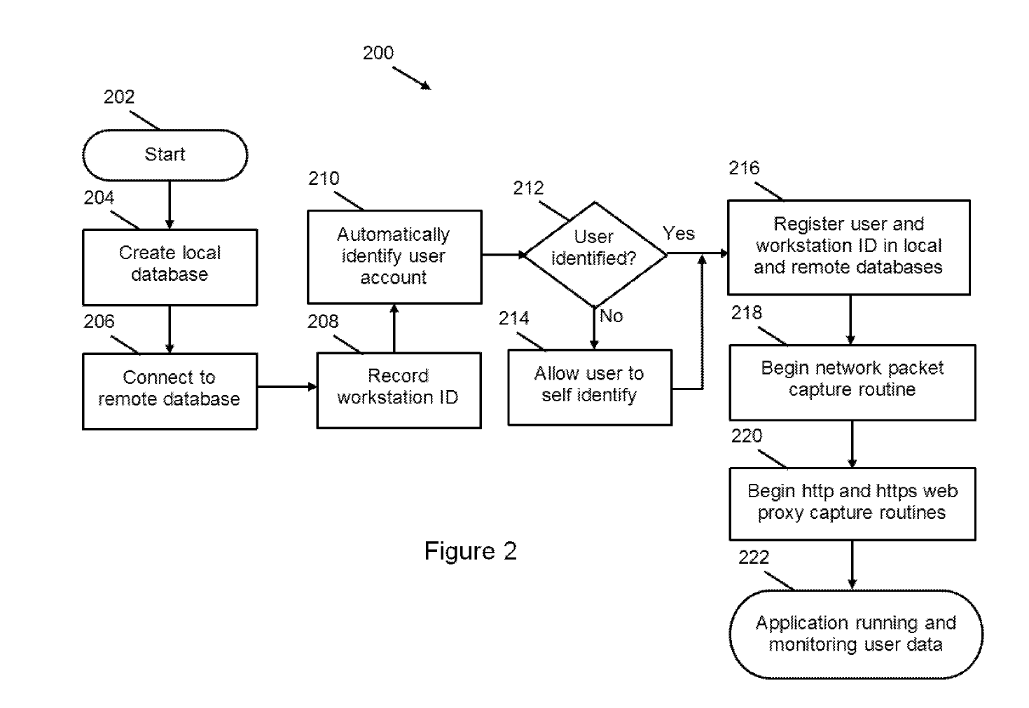

FIG. 2 shows an exemplary embodiment of an initialization procedure 200 that can be used by an RVU monitoring system. At block 202, the exemplary initialization procedure 200 application and software routines are started. At block 204, the system creates a temporary local database on the user's computer and connects the system processes to the local database. This local database can be used for various purposes including, for example, evaluation of detected data patterns, and/or as a temporary holding place for any recorded values before transfer to a remote database. At block 206, the system connects to a remote database that can be hosted at an Internet location or on the user's local area network. This remote database can be used for various purposes including, for example, permanent storage of recorded values, and/or for historical trending and analysis of the recorded values. At block 208, the system identifies and records the user's workstation identifier which can include, for example, a computer name and/or IP address(es). At block 210, the system attempts to identify the user through automatic processes. At block 212, the system checks if the user was successfully identified by the automatic processes. If the user was successfully identified by the automatic processes then control passes to block 216. If the user was not successfully identified, then at block 214 the user can self-identify and then control passes to block 216.

At block 216, the system registers the user and workstation identifiers in the local and remote databases. At block 218 and 220, the system begins the passive network monitoring routines which can include, for example, network packet capture/monitoring services (block 218) and/or HTTP and HTTPS web proxy services (block 220) to observe inbound and outbound data traffic. At block 222, completion of the initialization procedure 200 results in the system running and monitoring the user data and network traffic on the user's computer. This methodology allows for multiple instances of the software to be concurrently running on separate computers for the same user or different users. This allows the user to simultaneously run the application on multiple computers to analyze different systems and record values to the remote database. Using a remote database can allow comprehensive analysis of inputs from disparate systems.

The RVU monitoring system can monitor network traffic on several different levels of the OSI model to capture medical and voice recognition data transmitted by different systems which may communicate their traffic in different ways on these different levels. Each level used by relevant medical and voice recognition software systems can be monitored to assure analysis of the traffic from the relevant medical and voice recognition software systems. Medical and voice recognition software can transmit data and large streams identified by unique characteristics which segregate the data into information packets about specific exams.

The analysis includes discovering and recording unique characteristics of the various medical and voice recognition software programs. This can include monitoring for unique identifiers/characteristics (for example, exam identifiers) and then, once the unique identifiers are determined, discovering and recording the associated procedure description terminology. Because medical and voice recognition software may transmit a single report multiple times, the system can detect the status of the report as it relates to the unique identifier and procedure description. The pattern recognition of the RVU monitoring system can be accomplished by working backwards from known qualities and discovering the things that are not recognizable and then inspecting these to determine if they are indeed unique characteristics or identifiers. The unique characteristic can be associated with a particular user's records or voice model. At this point the collected data can be assembled into a structure that identifies the exam, the user, the type of exam performed, and the status of the exam. This can provide a framework for assembling the data in a structure that can be used to look up and calculate the RVU value as it pertains to this unique occurrence of the exam.

A matching database can be established to determine the possible combinations of known procedure code terminology as they relate to the CPT codes or current procedural terminology assignments. This matching database can be used in determining and calculating RVU values. The matching database can be established using the medical terminology used within the realm of relevant procedures, for example radiology exams. An exemplary matching database has been developed for the radiology area or field. The matching database can be for a particular area or multiple areas depending on the desired usage of the RVU monitoring system. The matching database can provide a structure and method for submitting detected procedural description terminology and calculating the appropriate RVU value based on these inputs.

As data patterns are discovered, the unique procedure description terminology as it relates to a unique exam identifier, exam status, dictation user, etc. can be submitted to a pattern recognition routine which compares the input terminology to the possible associations based on the known procedure description values. The pattern recognition routine can return an RVU value that can be stored in the software application records and/or in the user's database. This database may be stored locally on the user's computer or hosted on a network. The RVU values can be stored and compared as the unique identifiers are seen on subsequent transactions. If the associated procedure code description terminology changes, the RVU values can be recalculated as appropriate. The RVU values can also be compared, contrasted and trended over time.

The data pattern recognition routine can compare detected procedure description terms in various combinations of order and use similar matching words including partial words. For example, the letters “ABD” can also be associated with the word “abdomen.” The data pattern recognition routine can inspect and use other elements within the unique report identifier. Elements that determine the modality type used within the exam can be used to further narrow the matching pattern when determining the RVU value.

An alternative implementation of an RVU monitoring system can examine and compare a user's medical report and voice recognition dictation of the medical procedure with the procedure terminology that was used in creating the order from the medical facility. This can enable the RVU monitoring system to guide the user in making a more complete and accurate dictation and medical report. For example, the RVU monitoring system can monitor and compare an order from the medical facility for a three-view x-ray and detect that the user only mentions two distinct views in their dictation or medical report. The system can then prompt the user to confirm that indeed there were only two x-ray views performed or guide the user to complete the dictation or medical report by mentioning the third view.

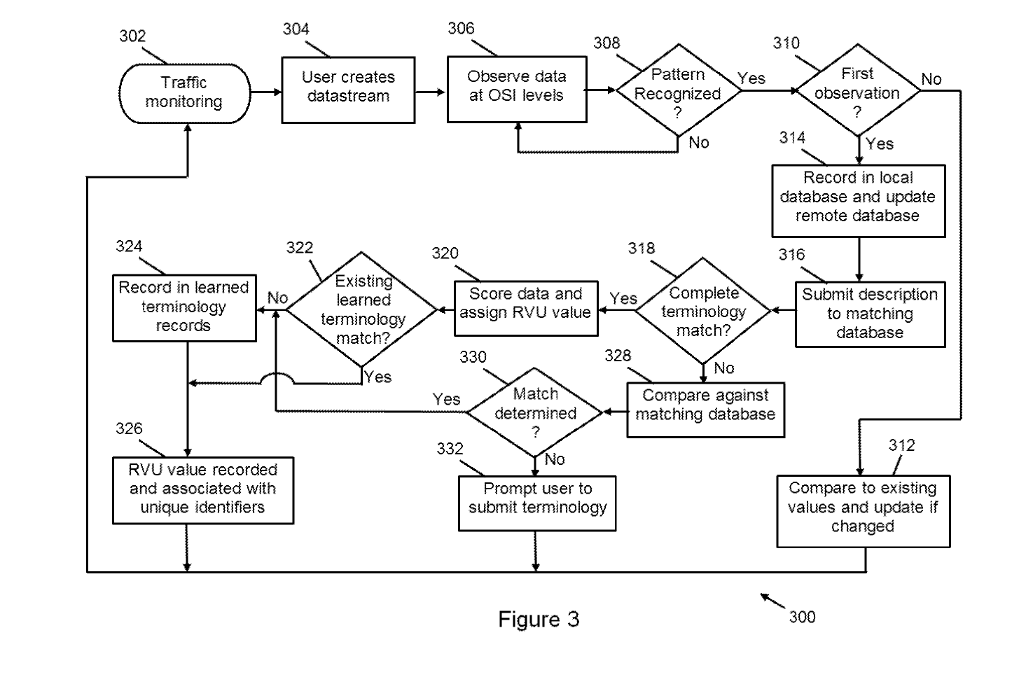

FIG. 3 shows an exemplary monitoring, analysis and evaluation embodiment 300 that can be used in an RVU monitoring system. The monitoring, analysis and evaluation starts at block 302 by monitoring computer network traffic and at block 304 where the user's interaction on the computer creates datastreams of structured text and voice recognition files. Block 306 illustrates that the traffic monitoring includes observing data at various Open System Interaction (OSI) levels including OSI levels 2-7. At block 308, the system looks for recognized patterns or elements. If no patterns or elements are recognized the system continues at block 306 to observe the data at the various OSI levels. The system can monitor numerous different user actions including, but not limited to, using a voice recognition system to monitor dictations, monitoring data entered in medical records applications, and/or monitoring modification of medical images or associated files. The system can monitor this user network traffic and look for known medical terminology. At block 308, when the system recognizes a data pattern or element, control passes to block 310.

At block 310, the system checks whether this is the first observation of this medical terminology and associated identifiers. When medical terminology is recognized, associated data elements can be analyzed and recorded by determining their relative proximity to the known medical terminology as it relates to the network packet structure. For example, as a medical term such as “chest x-ray” is observed, somewhere in the same network packets or http/https GET and POST data there may be unique identifiers about the exam such as a report number, a date/time stamp value, an order number or other similar non-protected patient data element. If this is the first observation of this medical terminology and associated identifiers then control passes to block 314, otherwise control passes to block 312. At block 312, where this is not the first observation of the terminology as it relates to the unique identifiers, the matching process can be performed to compare the recognized data items to the previously observed values stored in the database and the database records can be updated with new or modified information, such as exam status. From block 312, control passes back to block 302 to continue monitoring traffic.

At block 314, where this is the first observation of the medical terminology and associated identifiers, the recognized medical terminology and associated identifiers are recorded in the local database and used to update the remote database. Then at block 316, a procedure lookup/evaluation submission can be made to an evaluation process using the matching database. The evaluation submission can be performed by comparing different combinations of the medical terminology to the established patterns in the matching database. At block 318, the system checks whether a complete terminology match was made for the evaluation submission. If an exact match is found, control passes to block 320, otherwise control passes to block 328.

At block 320 where an exact match was found, an evaluation score can be determined and an RVU value can be assigned. If a high-confidence match is found, that match can be submitted to the “learned” terminology records that then can become eligible to be an exact match on later observations. High-confidence match values can be determined based on scoring mechanisms in the evaluation process and can be reviewed and updated periodically. At block 322, the system checks whether the match is to an existing “learned” terminology match. If the match is not an existing “learned” terminology match, then at block 324 the terminology match data is recorded in the “learned” terminology records and control passes to block 326. If the match is an existing “learned” terminology match, then control passes directly to block 326.

At block 326, the RVU value is recorded in the local and remote databases and associated with the medical procedure's unique identifiers. From block 326, control passes back to block 302 to continue monitoring network traffic.

If an exact match is not found at block 318, then at block 328 different term-by-term combinations can be compared with the elements of the matching database until either a high-confidence match is found or matching fails entirely. At block 330, the system checks whether a match is found. At block 330, if a match is found then control passes to block 324 where the terminology match data is recorded in the “learned” terminology records and control proceeds as described above. At block 330, if a match is not found then control passes to block 332 where the user can be presented with an opportunity to enter terminology for review and evaluation by the system, and the user entered information can be used to update and refine the matching criteria. While the system waits for a user response and after the user responds, it continues at block 302 to monitor computer network traffic.

This exemplary process can be used to extract RVU values from structured network traffic and voice recognition patterns, and to provide the ability to perform summation and comparative analysis in real-time with the user's actions.

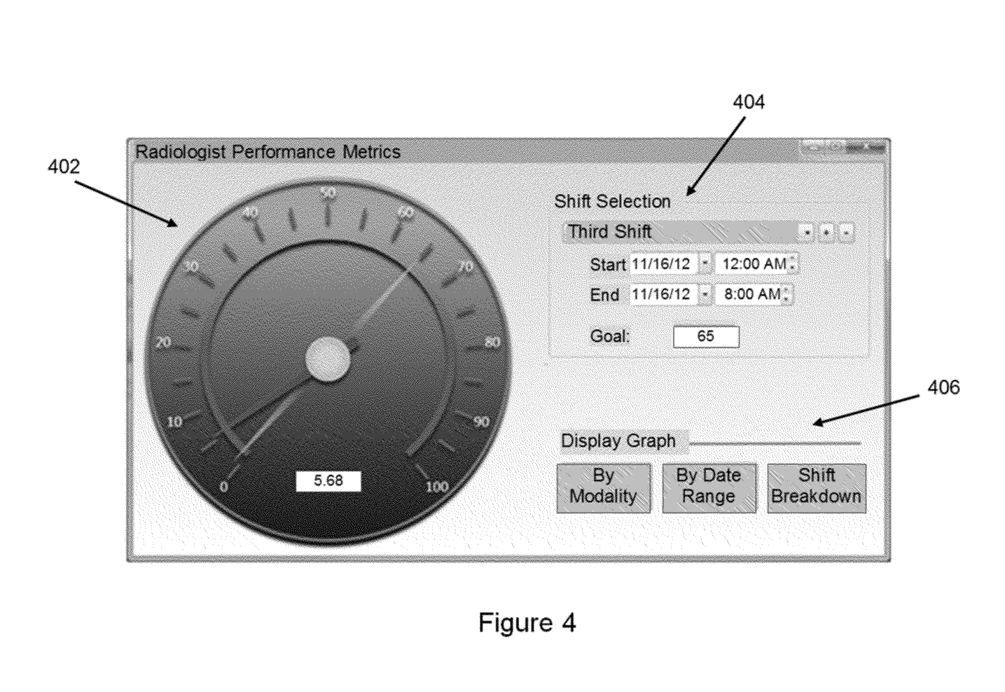

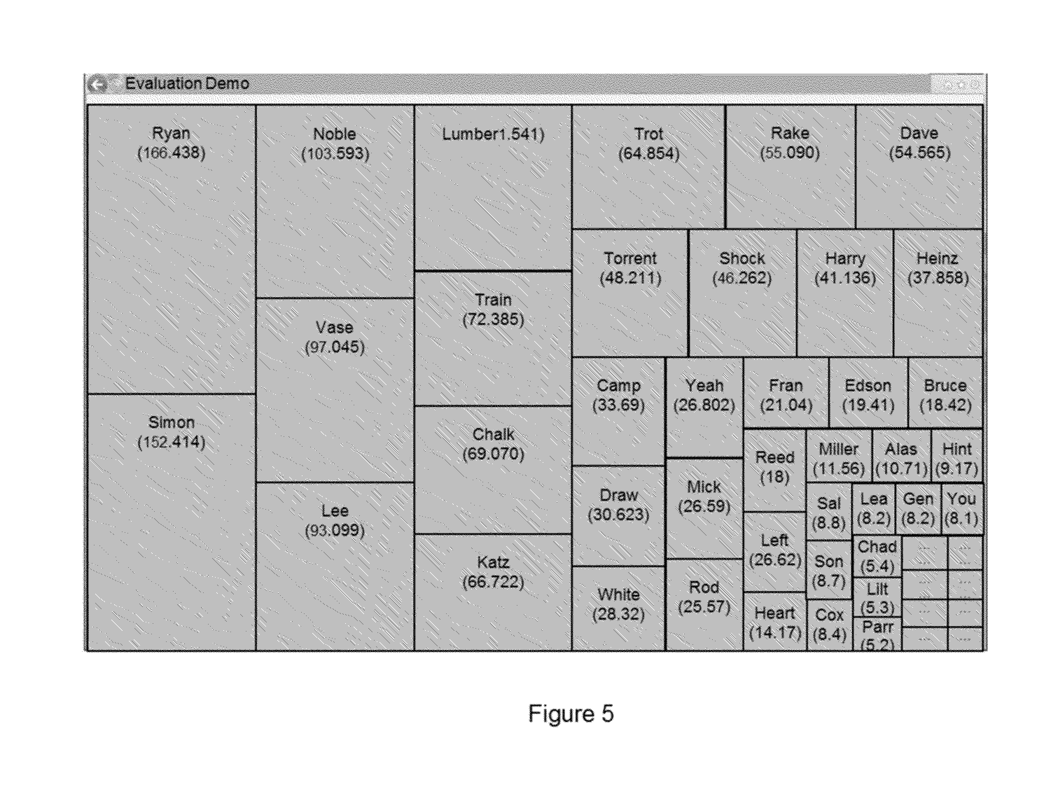

FIGS. 4 and 5 show some exemplary computer screenshots of outputs of an exemplary RVU monitoring system. There are many other possible views that can be set up for the user. FIG. 4 shows an RVU meter 402 with selection criteria to control the values displayed on the meter. The selection controls for this exemplary view include “Shift Selection” 404 and “Display Graph Criteria” 406. The Shift Selection 404 controls include a shift selection and start/end dates and times for the selected shift(s). The Display Graph Criteria 406 includes display by Modality, Date Range or Shift Breakdown. The exemplary meter 402 shows three pointers indicating the actual RVUs achieved so far on the shift (5.68, also displayed numerically at the base of the meter), the goal for RVUs on the shift (65), and a pacer arrow showing how many RVUs should be achieved by this point of time to reach the RVU goal if the RVUs were achieved uniformly over time during the shift.

FIG. 5 shows a visualization of the RVU contribution for various members of a group, team or staff over a user selected time period. Each of the individual blocks on the screen is associated with a person's name, and indicates the contribution of RVUs to the group by that person over the user selected time period. The total area of the combined blocks can show all of the RVUs performed by the group over the user selected time period.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. A Relative Value Unit (RVU) monitoring system for a computer system, the RVU monitoring system comprising:
a traffic monitoring component running on a user's computer, the traffic monitoring component passively monitoring network traffic entering and leaving the user's computer;
a matching algorithm database accessible from the user's computer, the matching algorithm database storing a plurality of recognized patterns, a plurality of procedure codes, and a plurality of RVU values, the matching algorithm database associating each of the plurality of procedure codes to an RVU value of the plurality of RVU values;
a pattern recognition component running on a user's computer, the pattern recognition component examining the monitored network traffic for a detected pattern that matches a matching recognized pattern of the plurality of recognized patterns in the matching algorithm database;
an evaluation component running on a user's computer, the evaluation component receiving the detected pattern and the matching recognized pattern from the pattern recognition component, the evaluation component using the matching algorithm database to derive a detected RVU value from the matching recognized pattern, the detected RVU value being one of the plurality of RVU values in the matching algorithm database, and the evaluation component updating a computer database with the detected RVU value.

2. The RVU monitoring system of claim 1, wherein the matching algorithm database further contains a plurality of current procedural terminology (CPT) codes, and the matching algorithm database associates each of the plurality of recognized patterns to an associated procedure code of the plurality of procedure codes, and associates each of the plurality of procedure codes to an associated CPT code of the plurality of CPT codes, and associates each of the plurality of CPT codes to an associated RVU value of the plurality of RVU values.

3. The RVU monitoring system of claim 2, wherein the evaluation component derives a detected CPT code of the plurality of CPT codes while deriving the detected RVU value from the matching recognized pattern, and the evaluation component notifies the user of the detected CPT code and the detected RVU value.

4. The RVU monitoring system of claim 1, wherein the evaluation component updates the computer database with the detected RVU value in real-time.

5. The RVU monitoring system of claim 1, further comprising an initialization component comprising:
a local database creation component creating a local database on the user's computer for use by the RVU monitoring system on the user's computer;
a remote database connection component connecting a remote database to the user's computer for use by the RVU monitoring system on the user's computer;
a workstation identification component automatically determining a computer identifier for the user's computer;
a user identification component determining a user identifier identifying the user of the user's computer; and
a registration component recording the computer identifier and the user identifier in the local and remote databases.

6. The RVU monitoring system of claim 5, wherein the user identification component comprises:
an automatic user identification component attempting to determine the user identifier without user interaction; and
a self-identification component activated when the automatic user identification component fails to determine the user identifier without user interaction, the self-identification component prompts the user to enter information enabling determination of the user identifier.

7. The RVU monitoring system of claim 1, wherein the traffic monitoring component comprises running HTTP and HTTPS proxy services and packet monitoring services on the user's computer to observe inbound and outbound network and data traffic.

8. The RVU monitoring system of claim 1, wherein the traffic monitoring component monitors network traffic on multiple levels of the Open Systems Interconnection (OSI) model.

9. The RVU monitoring system of claim 1, wherein the traffic monitoring component monitors data of voice recognition software programs entering the user's computer.

10. The RVU monitoring system of claim 1, further comprising:
a medical procedure order tracking component analyzing received medical orders, determining procedures requested by the received medical orders, and tracking the user's fulfillment of the procedures requested by the received medical orders; and
an order notification component notifying the user when procedures requested by the received medical orders remain to be fulfilled.

11. The RVU monitoring system of claim 1, wherein the evaluation component further comprises:
a first observation detection component analyzing associated detection data associated with the detected pattern, determining any identifiers in the associated detection data, examining the detected pattern and the identifiers in the associated detection data to determine whether the detected pattern is associated with a first observation of a process or with a previously observed process.

12. A Relative Value Unit (RVU) monitoring method running on a computer system, the RVU monitoring method comprising:
passively monitoring network traffic entering and leaving a user's computer;
examining the monitored network traffic for detected patterns that match recognized patterns in a matching algorithm database accessible from the user's computer, the matching algorithm database storing a plurality of recognized patterns and a plurality of RVU values, the matching algorithm database associating each of the recognized patterns to an RVU value of the plurality of RVU values;;
matching a detected pattern in the monitored network traffic with a matching recognized pattern of the plurality of recognized patterns in the matching algorithm database;
deriving a detected RVU value from the matching recognized pattern using the matching algorithm database; and
updating an RVU tracking database with the detected RVU value.

13. The RVU monitoring method of claim 12, wherein the matching algorithm database further contains a plurality of procedural codes and a plurality of current procedural terminology (CPT) codes, and the matching algorithm database associates each of the plurality of recognized patterns to an associated procedure code of the plurality of procedure codes, and associates each of the plurality of procedure codes to an associated CPT code of the plurality of CPT codes, and associates each of the plurality of CPT codes to an associated RVU value of the plurality of RVU values; and
wherein deriving a detected RVU value from the matching recognized pattern using the matching algorithm database comprises:
deriving a detected procedure code from the matching recognized pattern;
deriving a detected CPT code from the detected procedure code; and
deriving the detected RVU value from the detected CPT code.

14. The RVU monitoring method of claim 13, further comprising:
notifying the user of the detected CPT code and the detected RVU value.

15. The RVU monitoring method of claim 12, further comprising:
connecting a remote database to the user's computer for use by the RVU monitoring method;
automatically determining a computer identifier for the user's computer;
determining a user identifier identifying the user of the user's computer; and
recording the computer identifier and the user identifier in the remote databases.

16. The RVU monitoring method of claim 15, wherein determining a user identifier comprises:
attempting to automatically determine the user identifier without user interaction; and
prompting the user to enter information enabling determination of the user identifier when the attempt to automatically determine the user identifier fails.

17. The RVU monitoring method of claim 12, further comprising:
determining procedures requested by received medical orders;
tracking the user's fulfillment of the procedures requested by the received medical orders; and
notifying the user when procedures requested by the received medical orders remain to be fulfilled.

18. The RVU monitoring method of claim 12, further comprising:
analyzing detection data associated with the detected pattern;
determining any unique identifiers in the associated detection data;
comparing the detected pattern and the unique identifiers in the associated detection data with the RVU tracking database to determine whether the detected pattern is associated with a first observation of a medical procedure or with a previously observed medical procedure;
if the detected pattern is associated with a first observation of a medical procedure, recording a new record in the RVU tracking database with information derived from the detected pattern and the associated detection data; and
if the detected pattern is associated with a previously observed medical procedure, updating the record in the RVU tracking database for the previously observed medical procedure with any new or changed information derived from the detected pattern and the associated detection data.

19. The RVU monitoring method of claim 18, further comprising:
if it cannot be determined whether the detected pattern is associated with a first observation of a medical procedure or with a previously observed medical procedure, prompting the user to submit further information to make determination for the detected pattern.

20. The RVU monitoring method of claim 12, further comprising:
running multiple instances of the RVU monitoring method on separate computers; and
updating a common RVU tracking database with the detected RVU values of all of the multiple instances of the RVU monitoring method.
